(19) United States
(12) Patent Application Publication
(10) Pub. No.: US 2024/0071251 A1
(43) Pub. Date: Feb. 29, 2024

(54) SEWING SIMULATOR WITH ERASABLE MARKER

(71) Applicant: GRACEWOOD MANAGEMENT, INC., WEST VALLEY CITY, UT (US)

(72) Inventor: Jim Matthews Bagley, West Valley City, UT (US)

(21) Appl. No.: 18/458,801

(22) Filed: Aug. 30, 2023

Related U.S. Application Data
(60) Provisional application No. 63/374,072, filed on Aug. 31, 2022.

(51) Int. Cl. G09B 19/20; D05B 81/00

(52) U.S. Cl. CPC G09B 19/20; D05B 81/00

(57) ABSTRACT

A sewing simulator apparatus adapted for use with a sewing machine includes a tracing tool and a practice template. The tracing tool is configured to be selectively coupled to a head of the sewing machine. The practice template has practice lines configured to be traced by the operator with the tracing instrument of the tracing tool to allow the operator to practice sewing with the sewing machine.

### CROSS-REFERENCE TO RELATED APPLICATIONS

This application claims the benefit of U.S. Provisional Application Nos. 63/374,072, filed Aug. 31, 2022; the entire contents of that application are hereby incorporated by reference herein.

### FIELD OF DISCLOSURE

The present disclosure relates generally to sewing or quilting machines, and more specifically to methods for practicing using sewing or quilting machines.

### BACKGROUND

Sewing machines are used for stitching one or more pieces of fabric with thread. Some sewing machines are stationary such that fabric is fed under a needle of the sewing machine, while other sewing machines, like quilting machines, are maneuverable such that the needle may be moved across the fabric.

Maneuverable sewing machines allow an operator to create intricate patterns with the stitching. Such sewing or quilting machines, however, may also make it difficult to accurately follow a path on the fabric, such as a seam, a ditch line, or another desired pattern. Therefore, it may be helpful to practice using the maneuverable sewing machine to get better at accurately following a path on the fabric.

### SUMMARY

The present disclosure may comprise one or more of the following features and combinations thereof.

The present disclosure may comprise one or more of the following features and combinations thereof.

A sewing simulator apparatus may be adapted for use with a sewing machine. The sewing simulator apparatus may include a tracing tool, a tracing instrument, and a practice template. The tracing tool may be configured to be selectively coupled to a head of the sewing machine. The practice template may have practice lines configured to be traced by the operator with the tracing tool to allow the operator to practice sewing with the sewing machine.

In some embodiments, the tracing tool may include a tracing instrument, a tracing-instrument holder, and a holder mount. The tracing instrument may be configured to mark a surface. The tracing-instrument holder may be configured to support the tracing instrument in a tracing position. In the tracing position, the tracing instrument may extend at an angle relative to a needle bar axis of the sewing machine with a tip of the tracing instrument located adjacent to a sewing machine bed included in the sewing machine. The holder mount may extend from the tracing-instrument holder and may selectively couple to the head of the sewing machine to fix the tracing instrument for movement therewith. In this way, when an operator maneuvers the sewing machine, the tracing instrument follows the motion of the head of the sewing machine.

In some embodiments, the tracing-instrument holder may include a holder base and a tracing-instrument lock. The holder base may be shaped to include a tracing-instrument receiving aperture that extends therethrough. The tracing-instrument lock may be coupled to holder base.

In some embodiments, the tracing-instrument lock may be configured to change between an unlocked position and a locked position. In the unlocked position, the tracing instrument may be completely free to move relative to the tracing-instrument holder. In the locked position, the tracing-instrument lock may engage the tracing instrument to partially block movement of the tracing instrument relative to the tracing-instrument holder while in the tracing instrument is in tracing-instrument receiving aperture.

In some embodiments, the tracing-instrument holder may include a holder extension. The holder extension may extend from a first side surface of the holder base facing the sewing machine bed. The holder extension may form a portion of the tracing-instrument receiving aperture to increase the support of the tracing instrument.

In some embodiments, the tracing-instrument lock may be coupled a second side surface of the holder base. The second side surface of the holder base may face away from the sewing machine bed.

In some embodiments, the holder mount may include a mount flange and a fastener. The mount flange may extend from the tracing-instrument holder to the head of the sewing machine. The mount flange may extend from the tracing-instrument holder into a notch formed in the head of the sewing machine. The fastener may extend through the tracing-instrument holder and the mount flange into the head of the sewing machine.

In some embodiments, the practice lines of the practice template may be a desired pattern to be sewn with the sewing machine. In some embodiments, the practice template may be transparent and configured to be reused.

In some embodiments, the tracing instrument may be one of a marker, pen, and a pencil. In some embodiments, the tracing instrument may be a marker. In some embodiments, the tracing instrument may be a pen. In some embodiments, the tracing instrument may be a pencil.

In some embodiments, the tracing instrument may be spring-biased toward the sewing machine bed. The tracing instrument may be spring-biased toward the sewing machine bed so that the tip of the tracing instrument stays in contact with the practice template while the use moves the sewing machine.

According to another aspect of the present disclosure, a method for practicing using a sewing machine may include providing a tracing tool and a practice template. The tracing tool may be configured to be selectively coupled to a head of the sewing machine. The practice template may have practice lines configured to be traced with the tracing tool. The tracing tool may include a tracing instrument configured to mark a surface, a tracing-instrument holder configured to support the tracing instrument in a tracing position, and a holder mount that extends from the tracing-instrument holder.

In some embodiments, the method may further include coupling the holder mount of the tracing tool to the head of the sewing machine to fix the tracing instrument for movement therewith. In some embodiments, the method may further include inserting the tracing instrument into a tracing-instrument receiving aperture formed in the tracing-instrument holder so that the tracing instrument is in the tracing position. In the tracing position, the tracing instrument may extend at an angle relative to a needle bar axis of the sewing machine with a tip of the tracing instrument located adjacent to a sewing machine bed included in the sewing machine.

In some embodiments, the method may further include placing the practice template under the head of the sewing machine so that the tip of the tracing instrument overlies the practice template. In some embodiments, the method may further include moving the sewing machine so that the tip of the tracing instrument follows the practice lines on the practice template and makes a first tracing mark that substantially matches the practice lines on the practice template.

In some embodiments, the method may further include erasing the first tracing mark from the practice template after completing the first tracing mark. The method may further include repeating the step of moving the sewing machine so that the tip of the tracing instrument follows the practice lines on the practice template and makes a second tracing mark that substantially matches the practice lines on the practice template.

In some embodiments, the method may further include removing the tracing instrument from the tracing-instrument receiving aperture and removing the practice template out from under the head of the sewing machine. In some embodiments, the method may further include coupling a needle to a needle bar included on the sewing machine and moving the sewing machine in the same manner following the practice lines on the practice template.

In some embodiments, the method may further include locking the tracing instrument to the tracing-instrument holder. The tracing instrument may be locked to the tracing-instrument holder after inserting the tracing instrument into the tracing-instrument receiving aperture so that the tracing-instrument is partially blocked for movement relative to the tracing-instrument holder.

In some embodiments, the tracing-instrument holder may include a holder base and a tracing instrument lock. The holder base may be shaped to include the tracing-instrument receiving aperture. The tracing-instrument lock may be coupled to holder base.

In some embodiments, the tracing-instrument lock may be configured to change between an unlocked position in which the tracing-instrument is free to move relative to the tracing-instrument holder and a locked position in which the tracing-instrument lock engages the tracing instrument to partially block movement of the tracing instrument relative to the tracing-instrument holder while in the tracing instrument is in tracing-instrument receiving aperture. In some embodiments, locking the tracing instrument to the tracing-instrument holder may include changing the tracing-instrument lock from the unlocked position to the locked position.

In some embodiments, the tracing instrument may be spring-biased toward the sewing machine bed. The tracing instrument may be spring-biased toward the sewing machine bed so that the tip of the tracing instrument stays in contact with the practice template while the use moves the sewing machine.

In some embodiments, the holder mount may include a mount flange that extends from the tracing-instrument holder and a fastener. Coupling the holder mount of the tracing tool to the head of the sewing machine may include inserting the fastener through the tracing-instrument holder and the mount flange into the head of the sewing machine. In some embodiments, coupling the holder mount of the tracing tool to the head of the sewing machine may include inserting the mount flange of the holder mount into a notch formed in the head of the sewing machine.

In some embodiments, the practice lines of the practice template may be a desired pattern to be sewn with the sewing machine. In some embodiments, the practice template may be transparent.

In some embodiments, the tracing instrument is one of a marker, pen, and a pencil. In some embodiments, the tracing instrument may be a marker. In some embodiments, the tracing instrument may be a pen. In some embodiments, the tracing instrument may be a pencil.

These and other features of the present disclosure will become more apparent from the following description of the illustrative embodiments.

### BRIEF DESCRIPTION OF THE TRACINGS

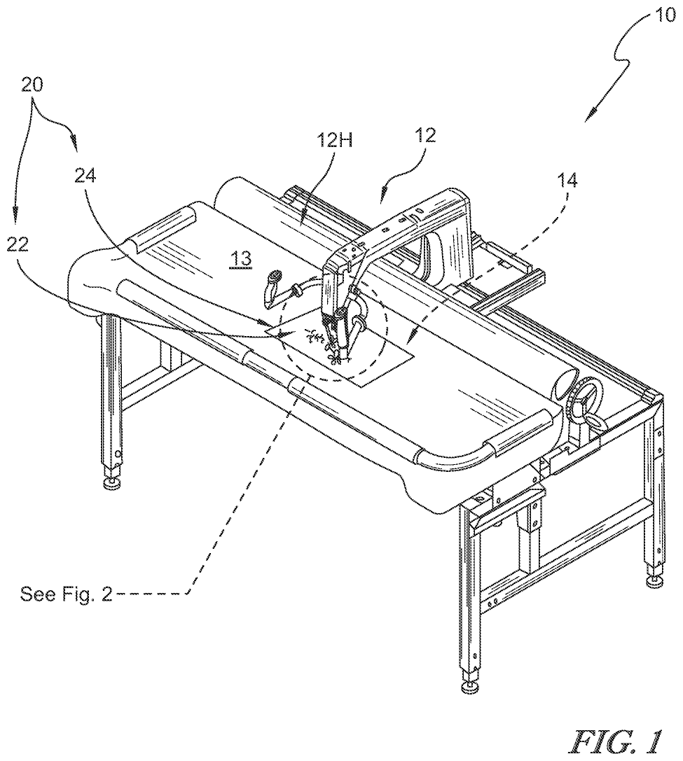

FIG. 1 is a perspective view of a sewing machine on a frame unit, and further showing a sewing simulator apparatus adapted for use with the sewing machine includes a tracing tool coupled to the sewing machine and a practice template having practice lines configured to be traced by the operator with the tracing tool to allow the operator to practice sewing with the sewing machine;

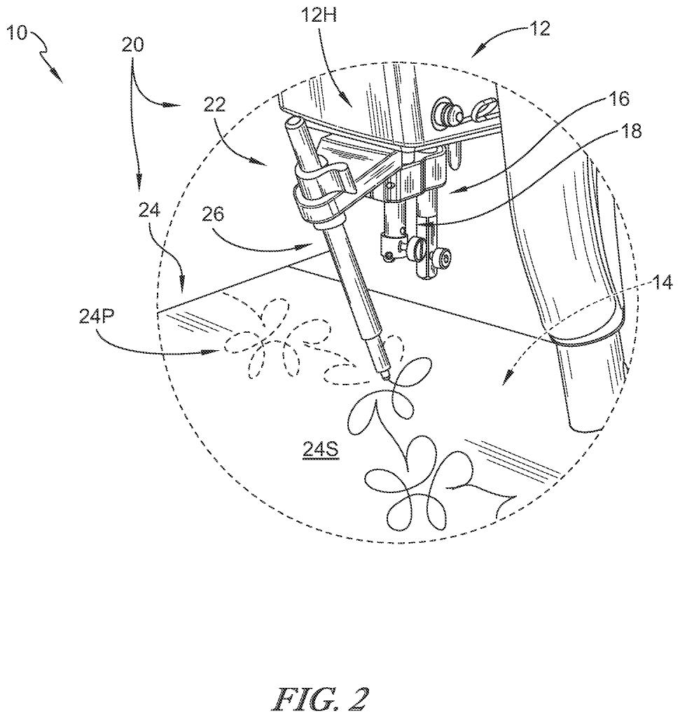

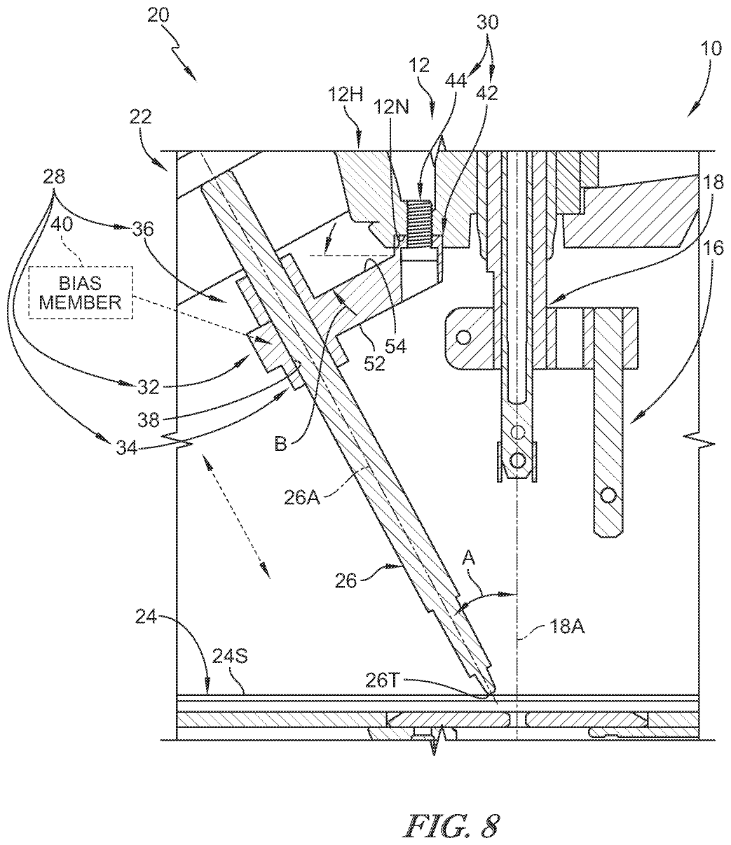

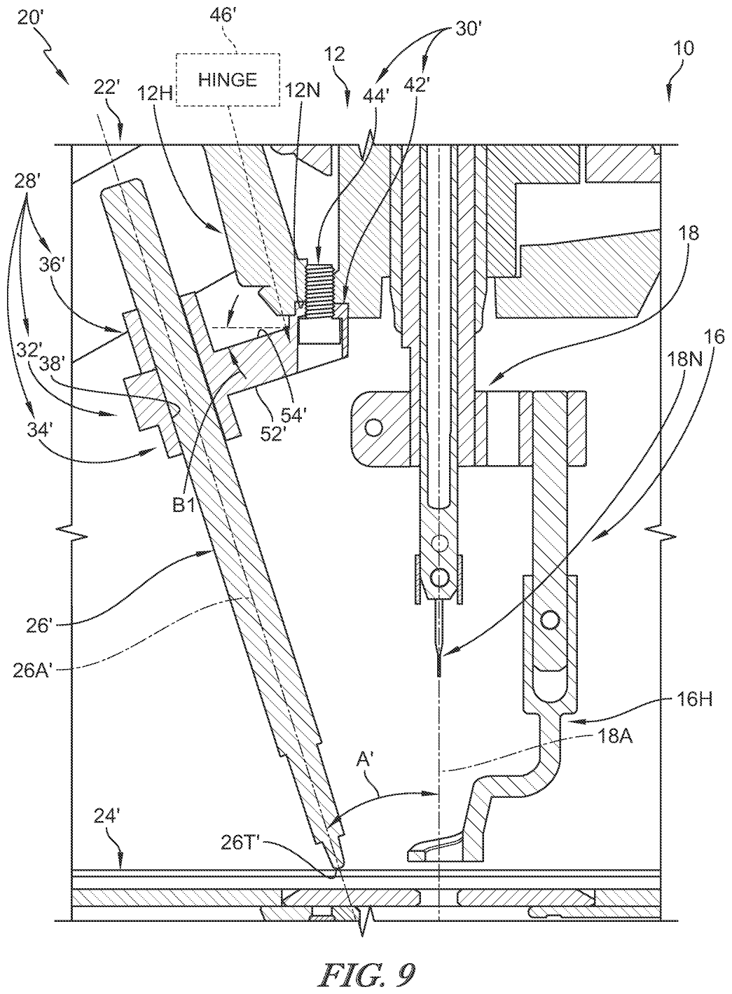

FIG. 2 is a detail view of FIG. 1 showing the tracing tool is coupled to a head of the sewing machine and the tracing tool includes a tracing instrument configured to mark a surface, a tracing-instrument holder configured to support the tracing instrument in a tracing position as shown in FIG. 8, and a holder mount that extends from the tracing-instrument holder and selectively couples to the head of the sewing machine to fix the tracing instrument for movement therewith so that when an operator maneuvers the sewing machine the tracing instrument follows the motion of the head of the sewing machine as shown in FIGS. 9 and 10;

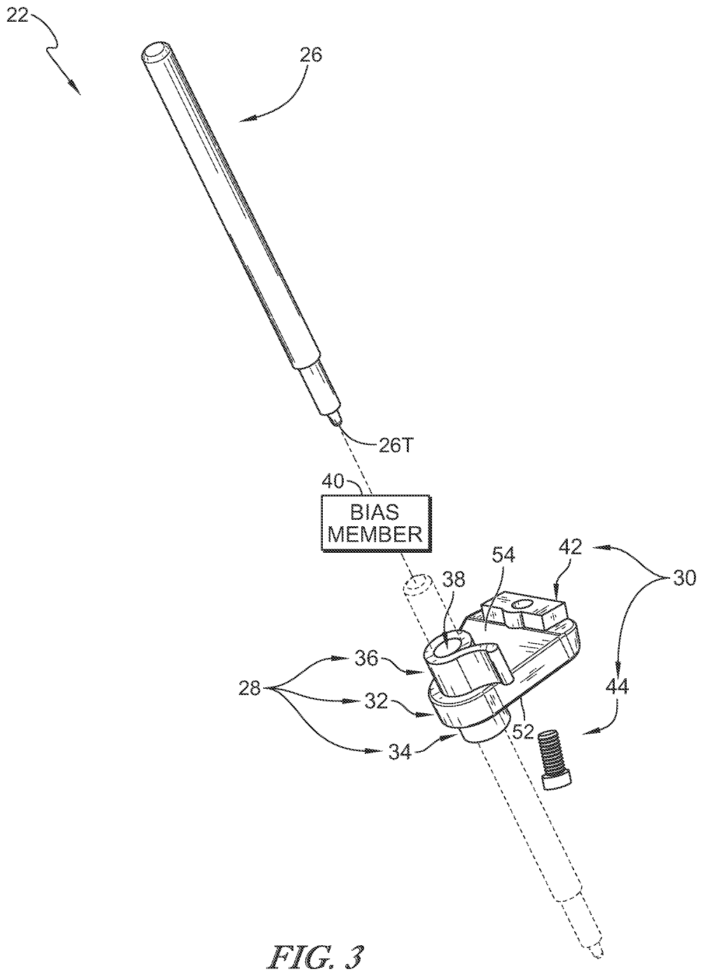

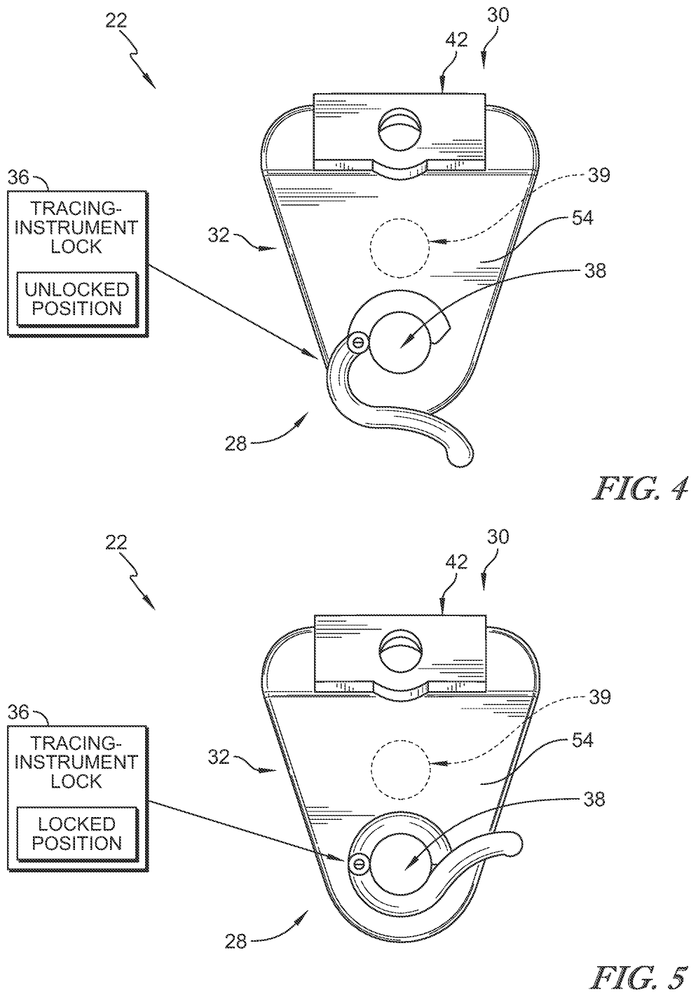

FIG. 3 is an exploded perspective view of the tracing tool showing the tracing-instrument holder of the tracing tool includes a holder base shaped to include a tracing-instrument receiving aperture and a tracing-instrument lock coupled to holder base that is configured to change between an unlocked position as shown in FIG. 4 and a locked position as shown in FIG. 5, and further showing the holder mount includes a mount flange that extends from the tracing-instrument holder and a fastener configured to be inserted through the tracing-instrument holder and the mount flange into the head of the sewing machine to fix the tracing tool with the sewing machine;

FIG. 4 is an elevation view of the tracing tool of FIG. 3 showing the tracing-instrument lock is in the unlocked position in which the tracing lock is spaced apart from the tracing instrument so that the tracing instrument is free to move relative to the tracing-instrument holder;

FIG. 5 is an view similar to FIG. 4 showing the tracing-instrument lock has moved to the locked position in which the tracing-instrument lock partially blocks movement of the tracing instrument relative to the tracing-instrument holder while in the tracing instrument is in tracing-instrument receiving aperture;

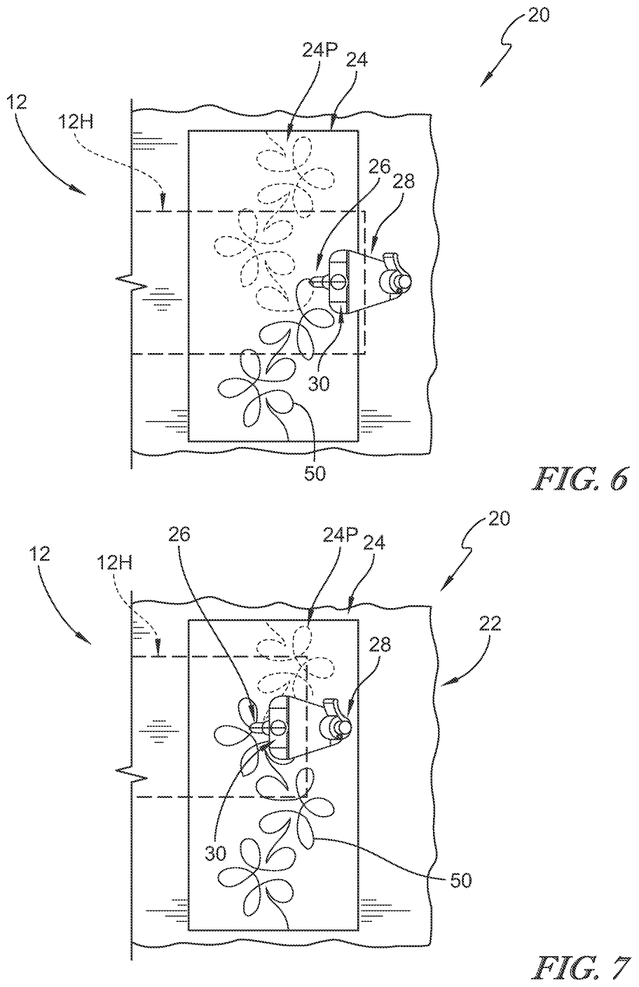

FIG. 6 is a top view of the sewing simulator apparatus being used with the sewing machine in which the operator aligns a tip of the tracing instrument with the practice lines on the practice template and moves the sewing machine so that the tip of the tracing instrument follows the practice lines on the practice template;

FIG. 7 is a view similar to FIG. 6 showing the operator has moved the sewing machine so that the tip of the tracing instrument follows the practice lines on the practice template;

FIG. 8 is a cross-section view of the sewing machine with the tracing tool attached showing the tracing instrument in the tracing position in which the tracing instrument extends at an angle relative to a needle bar axis of the sewing machine with a tip of the tracing instrument located adjacent to the sewing machine bed;

FIG. 9 is a cross-section view similar to FIG. 9 showing the position of the tracking instrument has been adjusted to cause the tip of the tracing instrument to contact the surface of the practice template.

FIG. 9 is another embodiment of a tracing tool for using in the sewing simulator apparatus of FIG. 3 showing the tracing-instrument holder

### DETAILED DESCRIPTION OF THE TRACINGS

For the purposes of promoting an understanding of the principles of the disclosure, reference will now be made to a number of illustrative embodiments illustrated in the tracings and specific language will be used to describe the same.

A sewing simulator apparatus 20 adapted for use with a sewing machine 10 is shown in FIGS. 1-10. The sewing machine 10 has a sewing machine body 12, sewing machine bed 14, a presser bar 16, and a needle bar 18 as shown in FIGS. 1 and 2.

The sewing simulator apparatus 20 includes a tracing tool 22 and a practice template 24 as shown in FIGS. 1 and 2. The tracing tool 22 is configured to be selectively coupled to a head 12H of the sewing machine 10. The practice template 24 has practice lines 24P configured to be traced by an operator with the tracing tool 22 to allow the operator to practice sewing with the sewing machine 10.

In the illustrative embodiment, the practice lines 24P are dashed lines like as shown in FIGS. 2, 6, and 7. In other embodiments, the practice lines 24P may be solid lines or another suitable line shape.

The practice lines 24P of the practice template 24 are a desired pattern to be sewn with the sewing machine 10. The operator may place the practice template 24 on the fabric 13 to be sewn by the sewing machine 10 or, alternatively, on another surface adjacent to the head 12H of the sewing machine 10, which the sewing machine 10 is moveable relative thereto. The operator may then move the sewing machine 10 to trace the practice lines 24P with the tracing tool 22 attached to the sewing machine 10.

The tracing tool 22 includes a tracing instrument 26, a tracing-instrument holder 28, and holder mount 30 as shown in FIGS. 2-8. The tracing instrument 26 is configured to mark a surface of the practice template 24. The tracing-instrument holder 28 is configured to support the tracing instrument 26 in a tracing position as shown in FIGS. 8 and 9. The holder mount 30 extends from the tracing-instrument holder 28 and selectively couples to the head 12H of the sewing machine 10 to fix the tracing instrument 26 for movement therewith. In this way, when the operator maneuvers the sewing machine 10 the tracing instrument 26 follows the motion of the head 12H of the sewing machine 10.

In the tracing position, the tracing instrument 26 extends at an angle A relative to a needle bar axis 18A of the sewing machine 10 with a tip 26T of the tracing instrument 26 located adjacent to the sewing machine bed 14. In the illustrative embodiment, the tracing-instrument holder 28 is configured to support the tracing instrument 26 in a first tracing position in which the tip 26T of the tracing instrument 26 is aligned with or located near the needle bar axis 18A as shown in FIG. 8.

In another embodiment, the tracing-instrument holder 28′ is configured to support the tracing instrument 26′ in a second tracing position in which the tip 26T′ of the tracing instrument 26′ is spaced apart from the needle bar axis 18A as shown in FIG. 9. The tracing-instrument holder 28′ extends at a different angle B′ relative to the head 12H of the sewing machine 12 compared to the tracing-instrument holder 28 in FIG. 8. The tracing-instrument holder 28 extends at an angle B relative to the head 12H of the sewing machine 12 as shown in FIG. 8.

Therefore, the tracing instrument 26′ extends at a different angle A′ relative to the needle bar axis 18A, which spaces the tip 26T′ of the tracing instrument 26′ apart from the needle bar axis 18A. This allows the needle 18N to be left in place on the needle bar 18 and a hopping foot 16H to be left in place on the pressure bar 16, while the sewing simulator apparatus 20′ is being used.

In other embodiments, the tracing-instrument holder 28 is adjustable relative to the head 12H of the sewing machine 12. For example, the tracing-instrument holder 28 may be shaped to include a first tracing-instrument receiving aperture 38 and a second tracing-instrument receiving aperture 39 as suggested in FIG. 8. Both the apertures 38, 39 are both configured to receive the tracing instrument 26. To adjust the tracing instrument 26 between the first and second tracing positions, the operator only need move the tracing instrument 26 between the two tracing-instrument receiving apertures 38, 39.

In another embodiment, the tracing-instrument holder 28 may be shaped to include a tracing-instrument receiving slot configured to receive the tracing instrument 26. The tracing instrument 26 may be moved within the tracing-instrument receiving slot to achieve the desired tracing position and held in place with a set screw or another suitable locking method.

The tracing-instrument holder 28 includes a holder base 32, a holder extension 34, and a tracing-instrument lock 36 as shown in FIGS. 2-8. The holder base 32 is shaped to include the tracing-instrument receiving aperture 38 that extends therethrough in the illustrative embodiment. The holder extension 34 extends from a first side surface 52 of the holder base 32 facing the sewing machine bed 14. The holder extension 34 forms a portion of the tracing-instrument receiving aperture 38 to increase the support of the tracing instrument 26. The tracing-instrument lock 36 is coupled to holder base 32 on a second side surface 54 of the holder base 32.

The tracing-instrument lock 36 is configured to change between an unlocked position as shown in FIG. 4 and an unlocked position as shown in FIG. 5. In the unlocked position, the tracing-instrument lock 36 is spaced apart from the tracing instrument 26 so that the tracing instrument 26 is completely free to move relative to the tracing-instrument holder 28. In the locked position, the tracing-instrument lock 36 engages the tracing instrument 26 to partially block movement of the tracing instrument 26 relative to the tracing-instrument holder 28 while in the tracing instrument 26 is in tracing-instrument receiving aperture 38. Specifically, the tracing-instrument lock 36 engages the tracing instrument 26 in the locked position to block radial movement of the tracing instrument 26 relative to the tracing-instrument holder 28.

Different tracing instruments 26 may be used in the tracing tool 22, which may have different lengths and diameters/thicknesses. When the tracing instrument 26 is inserted into the tracing-instrument receiving aperture 38, the tracing-instrument receiving aperture 38 may be larger in diameter than the tracing instrument 26. Therefore, the tracing-instrument lock 36 blocks radial movement of the tracing instrument 26 in the tracing-instrument receiving aperture 38.

Additionally, in the locked position, the tracing-instrument lock 36 allows axial movement of the tracing instrument 26 relative to the tracing-instrument holder 28 so that the tip 26T contacts the erasable surface 24S of the practice template 24. During use of the sewing simulator apparatus 20, the lock 36 allows the tracing instrument 26 to move to accommodate bumps or irregularities in the surface of the practice template 24.

For example, if the practice template 24 is placed on the fabric 13, the fabric may not be level or may create unevenness in the practice template 24. Since the tracing instrument 26 is free to move axially along the tracing-instrument axis 26A, the tracing instrument 26 may slide relative to the tracing-instrument holder 28 in response to the unevenness in the practice template 24.

In the illustrative embodiment, the tracing-instrument holder 28 includes a bias member 40 as suggested in FIGS. 3 and 8. The bias member 40 engages the tracing instrument 26 to bias the tracing instrument 26 toward the sewing machine bed 14, and thus the practice template 24. In this way, the tip 26T of the tracing instrument 26 is biased into contact with the practice template 24 to maintain contact with the practice template 24 during use of the sewing simulator apparatus 20.

In the illustrative embodiment, the holder mount 30 includes a mount flange 42 and a fastener 44 as shown in FIGS. 2-5. The holder mount 30 extends from the holder base 32 of the tracing-instrument holder 28 to the head 12H of the sewing machine 12. The holder mount 30 extends into a notch 12N formed in the head 12H of the sewing machine body 12 in the illustrative embodiment. The fastener 44 extends through the tracing-instrument holder 28 and the mount flange 40 into the head 12H of the sewing machine body 12.

In other embodiments, the holder mount 30 may be coupled to any portion of the sewing machine head 12H. Any other suitable fastener or fastener method may be used to couple the holder mount 30 to the sewing machine 12.

The tracing instrument 26 may be one of a marker, pen, and a pencil. In the illustrative embodiment, the tracing instrument 26 is an erasable marker and the practice template 24 has an erasable surface 24S so that the marks made by the tracing instrument 26 may be erased and the practice template 24 reused. The practice template 24 may be transparent.

To use the sewing simulator apparatus 20, the tracing tool 22 first needs to be coupled to the head 12H of the sewing machine 10. The holder mount 30 of the tracing tool 22 is coupled to the head 12H of the sewing machine 10 to fix the tracing instrument 26 for movement therewith.

To couple the holder mount 30 of the tracing tool 22 to the head 12H of the sewing machine 10, the mount flange 40 of the holder mount 30 is inserted into the notch 12N formed in the head 12H of the sewing machine 10. Then, the fastener 44 is inserted through the tracing-instrument holder 28 and the mount flange 40 into the head 12N of the sewing machine 10.

After the tracing-instrument holder 28 is coupled to the sewing machine 10, the tracing instrument 26 is inserted into the tracing-instrument receiving aperture 38 formed in the tracing-instrument holder 28. In this way, the tracing instrument 26 is in the tracing position and ready to mark the practice template 24.

To insert the tracing instrument 26 into the tracing-instrument receiving aperture 38, the tracing-instrument lock 36 needs to be in the unlocked position. Therefore, the tracing-instrument lock 36 may need to be moved from the locked position to the unlocked position if not already in the unlocked position. Once the tracing instrument 26 is inserted into the tracing-instrument receiving aperture 38, the tracing-instrument lock 36 may be moved to the locked position to block radial movement of the tracing instrument 26 relative to the tracing-instrument holder 28.

Before or after the tracing instrument 26 is attached to the tracing-instrument holder 28, the practice template 24 is placed under the head 12H of the sewing machine 12. The practice template 24 is placed under the head 12H of the sewing machine 12 so that the tip 26T of the tracing instrument 26 overlies, or will overlie the practice template 24. Once the practice template 24 is placed under the head 12H of the sewing machine 12 the tip 26T of the tracing instrument 26 contacts the practice template 24.

The operator then moves the sewing machine 10 so that the tip 26T of the tracing instrument 26 follows the practice lines 24P on the practice template 24 as suggested in FIGS. 6 and 7. By moving the sewing machine 10 to trace the practice lines 24P, the operator makes a first tracing mark 50 that substantially matches the practice lines 24P on the practice template 24.

Based on the operator's experience, the first tracing mark 50 may not exactly match the practice lines 24P on the practice template 24. However, with practice, the operator may be able to trace the practice lines 24P so that the first tracing mark 50 more accurately matches the practice lines 24P on the practice template 24.

To continue practice, the operator may erase the first tracing mark 50 from the practice template 24 after completing the first tracing mark 50. The operator may then repeat tracing the practice lines 24P by moving the sewing machine 10 so that the tip 26T of the tracing instrument 26 follows the practice lines 24P on the practice template 24. This will make a second tracing mark that substantially matches the practice lines 24P on the practice template 24.

The operator may erase and re-trace the practice lines 24P as many times as desired before actually trying to sew the pattern on the fabric. Once the operator wishes to sew the fabric, the tracing tool 22 needs to be removed from the head 12H of the sewing machine 10. The tracing instrument 26 may be removed from the tracing-instrument receiving aperture 38 and the practice template 24 may be removed out from under the head 12H of the sewing machine 10. To remove the tracing instrument 26, the tracing-instrument lock 36 may need to be moved to the unlocked position so that the tracing instrument 26 is free to move relative to the tracing-instrument holder 28. In some embodiments, the tracing-instrument holder 28 may also be removed from the sewing machine heat 12H by removing the fastener 44.

Then, the operator may couple a needle 18N to the needle bar 18 of the sewing machine 10. The fabric 13 may need to be placed under the head 12H of the sewing machine 10 before the operator can begin sewing. Once the fabric is in place, the operator turns on the sewing machine 10 and moves the sewing machine 10 in the same manner as when they followed the practice lines 24P on the practice template 24.

In another embodiment, as shown in FIG. 9, the needle 18N may already be coupled to the needle bar 18 of the sewing machine 10, while the tracing tool 22 is coupled to the sewing machine head 12H. Another embodiment of a sewing simulator apparatus 20′ in accordance with the present disclosure is shown in FIG. 9. The sewing simulator apparatus 20′ is substantially similar to the sewing simulator apparatus 20 shown in FIGS. 1-8 and described herein. The description of the sewing simulator apparatus 20 is incorporated by reference to apply to the sewing simulator apparatus 20′, except in instances when it conflicts with the specific description and the drawings of the sewing simulator apparatus 20′.

The sewing simulator apparatus 20′ includes a tracing tool 22′ and a practice template 24′ as shown in FIG. 9. The tracing tool 22′ is configured to be selectively coupled to a head of the sewing machine 10. The practice template 24′ has practice lines (not shown) configured to be traced by an operator with the tracing tool 22′ to allow the operator to practice sewing with the sewing machine 10.

The tracing tool 22′ includes a tracing instrument 26′, a tracing-instrument holder 28′, and holder mount 30′ as shown in FIG. 9. The tracing instrument 26′ extends along a tracing-instrument axis 26A′ and is configured to mark a surface of the practice template 24′. The tracing-instrument holder 28′ is configured to support the tracing instrument 26. The holder mount 30 extends from the tracing-instrument holder 28 and selectively couples to the head of the sewing machine 10 to fix the tracing instrument 26 for movement therewith

The tracing-instrument holder 28′ is configured to support the tracing instrument 26 in the second tracing position in which the tip 26T′ of the tracing instrument 26′ is spaced apart from the needle bar axis 18A as shown in FIG. 9. The tracing-instrument holder 28′ extends at a different angle B′ relative to the head 12H of the sewing machine 12 compared to the tracing-instrument holder 28 in FIG. 8, which spaces the tip 26T′ of the tracing instrument 26′ apart from the needle bar axis 18A. This allows the needle 18N to be left in place on the needle bar 18 and a hopping foot 16H to be left in place on the pressure bar 16, while the sewing simulator apparatus 20′ is being used.

The tracing-instrument holder 28′ includes a holder base 32′, a holder extension 34′, and a tracing-instrument lock 36′ as shown in FIG. 9. The holder base 32′ is shaped to include the tracing-instrument receiving aperture 38′ that extends therethrough. The holder extension 34′ extends from a first side surface 52′ of the holder base 32′ facing the sewing machine bed 14. The tracing-instrument lock 36′ is coupled to holder base 32′ on a second side surface 54′ of the holder base 32′.

The holder mount 30′ includes a mount flange 42′ and a fastener 44′ as shown in FIG. 9. The holder mount 30′ extends from the holder base 32 of the tracing-instrument holder 28′ to the head 12H of the sewing machine 12. The holder mount 30′ extends into a notch 12N formed in the head 12H of the sewing machine body 12 in the illustrative embodiment. The fastener 44′ extends through the tracing-instrument holder 28′ and the mount flange 40′ into the head 12H of the sewing machine body 12.

In other embodiments, the holder mount 30′ may further include a hinge 46′ as suggested in FIG. 9 The hinge 46′ extends between and interconnects the tracing-instrument holder 28′ and the mount flange 42′ of the holder mount 30′ so that the tracing-instrument holder 28′ is pivotable relative to the holder mount 30′. To adjust the tracing position of the tracing instrument 26′, the operator may adjust the angle B′ of the tracing-instrument holder 28′ relative to the head 12H of the sewing machine 12 by pivoting the tracing-instrument holder 28′ using the hinge 46′.

Therefore, when using the sewing simulator apparatus 20′, to switch between tracing and actually sewing, the operator may pivot the hinge to cause the tracing-instrument holder 28′ to move relative to the head 12H of the sewing machine 10 and out of the operator's visual of the needle 18N. In this way, the operator may not have to remove the tracing tool 22′ from the sewing machine 10 and/or remove/attach the needle 18N each time the operator wants to switch between practicing and sewing

While the disclosure has been illustrated and described in detail in the foregoing tracings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A sewing simulator apparatus adapted for use with a sewing machine, the sewing simulator apparatus comprising:
a tracing tool configured to be selectively coupled to a head of the sewing machine, the tracing tool comprising:
a tracing instrument configured to mark a surface;
a tracing-instrument holder configured to support the tracing instrument in a tracing position in which the tracing instrument extends at an angle relative to a needle bar axis of the sewing machine with a tip of the tracing instrument located adjacent to a sewing machine bed included in the sewing machine; and
a holder mount that extends from the tracing-instrument holder and selectively couples to the head of the sewing machine to fix the tracing instrument for movement therewith so that when an operator maneuvers the sewing machine the tracing instrument follows the motion of the head of the sewing machine; and
a practice template having practice lines configured to be traced by the operator with the tracing instrument of the tracing tool to allow the operator to practice sewing with the sewing machine.

2. The sewing simulator apparatus of claim 1, wherein the tracing-instrument holder comprises:
a holder base shaped to include a tracing-instrument receiving aperture that extends therethrough; and
a tracing-instrument lock coupled to holder base and configured to change between an unlocked position in which the tracing instrument is completely free to move relative to the tracing-instrument holder and a locked position in which the tracing-instrument lock engages the tracing instrument to partially block movement of the tracing instrument relative to the tracing-instrument holder while in the tracing instrument is in tracing-instrument receiving aperture.

3. The sewing simulator apparatus of claim 2, wherein the tracing-instrument holder comprises:
a holder extension that extends from a first side surface of the holder base facing the sewing machine bed and forms a portion of the tracing-instrument receiving aperture to increase the support of the tracing instrument, and
wherein the tracing-instrument lock is coupled a second side surface of the holder base facing away from the sewing machine bed.

4. The sewing simulator apparatus of claim 2, wherein the holder mount includes a mount flange that extends from the tracing-instrument holder to the head of the sewing machine and a fastener that extends through the tracing-instrument holder and the mount flange into the head of the sewing machine.

5. The sewing simulator apparatus of any one of claims 1-4, wherein the practice lines of the practice template are a desired pattern to be sewn with the sewing machine.

6. The sewing simulator apparatus of claim 5, wherein the practice template is transparent and configured to be reused.

7. The sewing simulator apparatus of any one of claims 1-4, wherein the tracing instrument is one of a marker, pen, and a pencil.

8. The sewing simulator apparatus of claim 1, wherein the holder mount includes a mount flange that extends from the tracing-instrument holder to the head of the sewing machine and a fastener that extends through the tracing-instrument holder and the mount flange into the head of the sewing machine.

9. The sewing simulator apparatus of any one of claims 1-4, wherein tracing instrument is spring-biased toward the sewing machine bed so that the tip of the tracing instrument stays in contact with the practice template while the use moves the sewing machine.

10. A method for practicing using a sewing machine, the method comprising:
providing a tracing tool configured to be selectively coupled to a head of the sewing machine and a practice template having practice lines configured to be traced with the tracing tool, the tracing tool comprising a tracing instrument configured to mark a surface, a tracing-instrument holder configured to support the tracing instrument in a tracing position, and a holder mount that extends from the tracing-instrument holder;
coupling the holder mount of the tracing tool to the head of the sewing machine to fix the tracing instrument for movement therewith;
inserting the tracing instrument into a tracing-instrument receiving aperture formed in the tracing-instrument holder so that the tracing instrument is in the tracing position in which the tracing instrument extends at an angle relative to a needle bar axis of the sewing machine with a tip of the tracing instrument located adjacent to a sewing machine bed included in the sewing machine,
placing the practice template under the head of the sewing machine so that the tip of the tracing instrument overlies the practice template, and
moving the sewing machine so that the tip of the tracing instrument follows the practice lines on the practice template and makes a first tracing mark that substantially matches the practice lines on the practice template.

11. The method of claim 10, further comprising:
erasing the first tracing mark from the practice template after completing the first tracing mark; and
repeating the step of moving the sewing machine so that the tip of the tracing instrument follows the practice lines on the practice template and makes a second tracing mark that substantially matches the practice lines on the practice template.

12. The method of claim 11, further comprising:
removing the tracing instrument from the tracing-instrument receiving aperture;
removing the practice template out from under the head of the sewing machine;
coupling a needle to a needle bar included on the sewing machine;
moving the sewing machine in the same manner following the practice lines on the practice template.

13. The method of claim 10, further comprising:
locking the tracing instrument to the tracing-instrument holder after inserting the tracing instrument into the tracing-instrument receiving aperture so that the tracing-instrument is partially blocked for movement relative to the tracing-instrument holder.

14. The method of claim 13, wherein the tracing-instrument holder comprises:
a holder base shaped to include the tracing-instrument receiving aperture; and
a tracing-instrument lock coupled to holder base and configured to change between an unlocked position in which the tracing-instrument is free to move relative to the tracing-instrument holder and a locked position in which the tracing-instrument lock engages the tracing instrument to partially block movement of the tracing instrument relative to the tracing-instrument holder while in the tracing instrument is in tracing-instrument receiving aperture, and
wherein locking the tracing instrument to the tracing-instrument holder includes changing the tracing-instrument lock from the unlocked position to the locked position.

15. The method of claim 10, wherein tracing instrument is spring-biased toward the sewing machine bed so that the tip of the tracing instrument stays in contact with the practice template while the use moves the sewing machine.

16. The method of one of claims 10-15, wherein the holder mount comprises:
a mount flange that extends from the tracing-instrument holder; and
a fastener, and
wherein coupling the holder mount of the tracing tool to the head of the sewing machine includes inserting the fastener through the tracing-instrument holder and the mount flange into the head of the sewing machine.

17. The method of one of claims 10-15, wherein the practice lines of the practice template are a desired pattern to be sewn with the sewing machine.

18. The method of one of claims 10-15, wherein the practice template is transparent.

19. The method of one of claims 10-15, wherein the tracing instrument is one of a marker, pen, and a pencil.
